(19) United States
(12) Patent Application Publication
(10) Pub. No.: US 2014/0316924 A1
(43) Pub. Date: Oct. 23, 2014

(54) Method, Apparatus and Program Product Facilitating Contract Formation With Labor Component

(71) Applicant: INTERNATIONAL BUSINESS MACHINES CORPORATION, Armonk, NY (US)

(72) Inventors: Richard G. Bednar, Austin, TX (US); Amelia C. Carruth, Austin, TX (US); Glenn C. Godoy, Austin, TX (US); Mark Kemp, Austin, TX (US); Gautam Majumdar, Austin, TX (US); Russell E. Parks, Austin, TX (US); Piyawadee Sukaviriya, Austin, TX (US)

(73) Assignee: International Businiess Machines Corporation, Armonk, NY (US)

(21) Appl. No.: 13/865,517

(22) Filed: Apr. 18, 2013

(51) Int. Cl. G06Q 30/06

(52) U.S. Cl. CPC G06Q 30/0611
USPC 705/26.4

(57) ABSTRACT

A method, apparatus and program product which facilitate contract formation by making explicit the labor content of a bid presented by a second party (potential supplier) to a first party (buying the services or goods). Software executing on an information handling system and controllably accessible to both parties which provides a common set of the job roles, job skills and costs associated with a bid to be presented. Such clarification by use of a common taxonomic table enables the buying party to better understand the cost build up for the labor component and to rank the cost build up among several bidders.

### FIELD AND BACKGROUND OF INVENTION

Procurement of services or goods is a long standing and established practice among businesses. Such a process typically begins with a request for proposal (RFP) or a similar expression of a need for one or both of services and goods by a first party, followed by responses from second parties interested in doing business with the first party. Formation of a contract following such exchanges may take many forms, including a fixed price, supplier's costs plus a fee, or other arrangements. Often in the exchanges leading up to contract formation, the first party procuring the services or goods will wish to have some insight into the way in which the second party will perform the contract. Such insights may include supplier's staffing with personnel, materials chosen, fit and finish of goods, reputation of the supplier and other factors. In some practices, such elements are reduced to provisions in a statement of work.

Particularly on the issues of staffing with personnel, it is often important to the first party, buying the services or goods, that the labor content be clearly understood. Heretofore, conventional practices have failed to reach the level of detail regarding the labor content desirable as negotiation for contract formation goes forward.

### SUMMARY OF THE INVENTION

What is here described and taught are a method, apparatus and program product which facilitate contract formation by making explicit the labor content of a bid presented by a second party (potential supplier) to a first party (buying the services or goods). As will become more clear, this is accomplished by the technical effect of software executing on an information handling system in which both parties use a pre-configured common set of job roles, job skills and costs associated with a bid to be presented to clarify the details underlying the bid. Such clarification enables the buying party to better understand the cost build up for the labor component and to rank the cost build up among several bidders.

### BRIEF DESCRIPTION OF DRAWINGS

Some of the purposes of the invention having been stated, others will appear as the description proceeds, when taken in connection with the accompanying drawings, in which:

FIG. 1 is a flowchart representation of the process here taught;

FIG. 2 is a representation of an information handling system; and

FIG. 3 is a representation of a tangible computer readable medium.

### DETAILED DESCRIPTION OF INVENTION

While the present invention wall be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

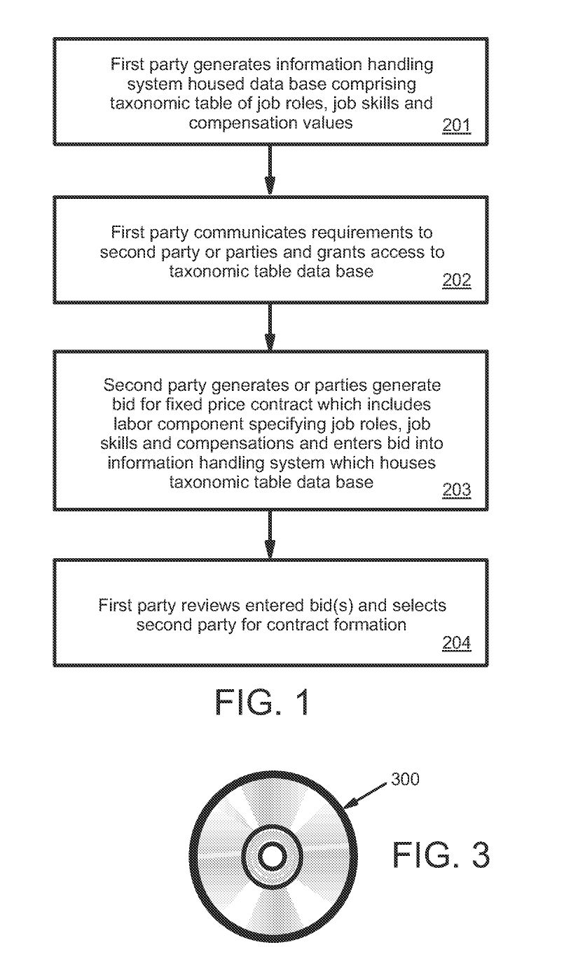

Turning first to FIG. 1, what is represented there is a shortened form of flow chart for the method taught here, To begin (201), a first party generates, as a data base stored in an information handling system (about which more is said hereinafter), a taxonomic table of job roles, job skills and compensation values. The compensation values are based on the first party's knowledge of fair market value of a set of job roles and skills across a number of possible markets. The first party commonly includes a requester in need of the goods or services for which a bid is solicited and a buyer responsible for the negotiation of a fixed price contract. The first party will communicate (202) to a plurality of second parties under consideration to become suppliers the first party requirements for the supply of one of goods and services and grant the second parties access to the information handling system and to the generated data base stored therein. In generating a response to the communicated requirement (203), the second parties will access the data base and select from the allowed job roles and job skills those deemed necessary and appropriate to the response being crafted. In that access and selection, the taxonomic table and its access may appear as follows:

Through accessing the first party generated and owned data, the second parties generate bids for a fixed price contract which include a labor component specifying job roles, job skills and compensation values taken from the taxonomic table to which access has been granted. The prospective suppliers will then enter the generated bid (203), including the full labor component information (number of personnel, job roles, job skills and compensation) into the information handling system for review by the first party.

The information handling system has program code executing on the information handling system which compiles bids entered by a plurality of second parties into a unique request response showing the elements which make up the bid including details of the labor component specifying job roles, job skills and compensation values taken from the taxonomic table. The buyer to then builds up an analysis of all costs associated with the project and ranks suppliers in terms of personnel contemplated (by roles, skills and compensation) as well as other elements. This analysis is a significant aid to the buyer in selecting a supplier with whom to complete contract formation. This analysis is done through the action of a spreadsheet compilation of the bids.

As elements of this procedure, the first party in granting access to the second party to the generated data base stored in the information handling system may grant access to a defined subset of the taxonomic table relevant to the communicated requirements. Further, the second party in generating a bid will define for the first party the labor component needed, in the prospective supplier's view, to meet the first party communicated requirements.

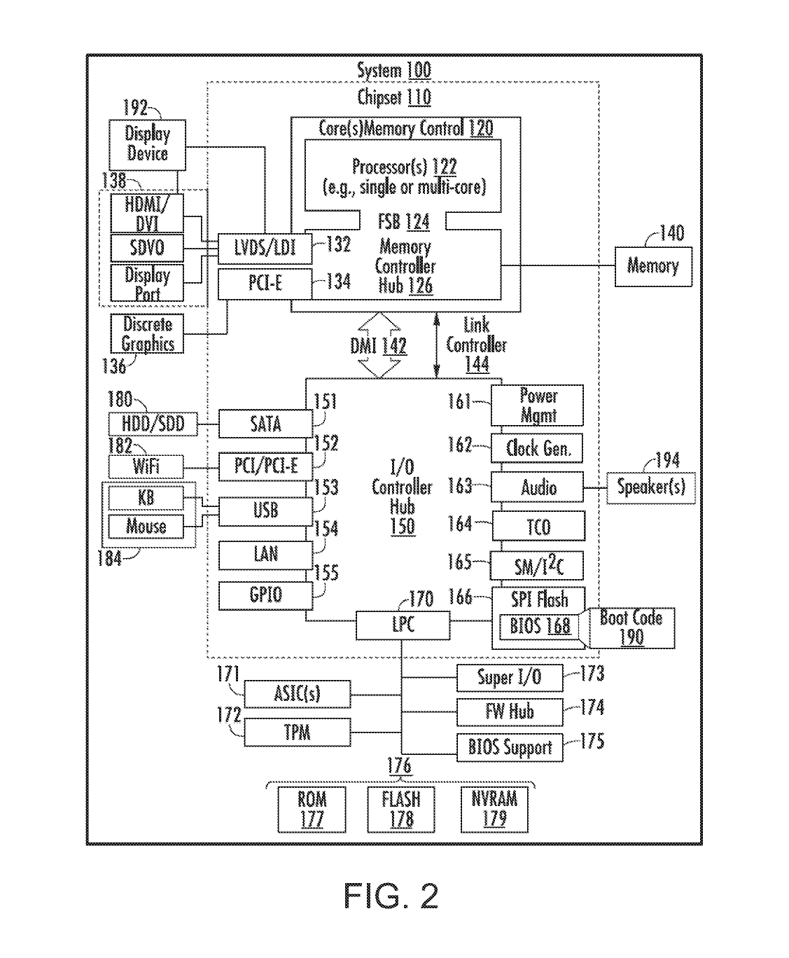

Turning now to FIG. 2, the term “circuit” or “circuitry” may be used herein in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

While various exemplary circuits or circuitry are discussed, FIG. 2 depicts a block diagram of an illustrative exemplary information handling or computer system 100. The system 100 may be a server system, a desktop computer system or a workstation computer; however, as apparent from the description herein, a server or other machine may include other features or only some of the features of the system 100. The system 100 may function in the process of FIG. 1 as the repository of the data base generated by the first party and the response(s) of a second party or parties given access to the taxonomic table stored in the information handling system.

The system 100 of FIG. 2 includes a so-called chipset 110 (a group of integrated circuits, or chips, that work together, chipsets) with an architecture that may vary depending on manufacturer (e.g., INTEL®, AMD®, etc.). The architecture of the chipset 110 includes a core and memory control group 120 and an I/O controller hub 150 that exchange information (e.g., data, signals, commands, etc.) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (e.g., single or multi-core) and a memory controller hub 126 that exchange information via a front side bus (FSB) 124; noting that components of the group 120 may be integrated in a chip that supplants the conventional “northbridge” style architecture.

In FIG. 2, the memory controller hub 126 interfaces with working memory 140 (e.g., to provide support for a type of RAM that may be referred to as “system or working memory”). The memory controller hub 126 further includes a LVDS interface 132 for a display device 192 (e.g., a CRT, a flat panel, a projector, etc.). A block 138 includes some technologies that may be supported via the LVDS interface 132 (e.g., serial digital video, HDMI/DVI, display port). The memory controller hub 126 also includes a PCI-express interface (PCI-E) 134 that may support discrete graphics 136. In FIG. 1, the I/O hub controller 150 includes a SATA interface 151 (e.g., for longer term, non-transitory memory such as HDS, SDS, etc.), a PCI-E interface 152 (e.g., for wireless connections 182), a USB interface 153 (e.g., for input devices 184 such as keyboard, mice, cameras, phones, storage, etc.), a network interface 154 (e.g., LAN), a GPI interface 155, a LPC interface 170 (for ASDICS 171, a T.M. 172, a super I/O 173, a firmware hub 174, BIOS support 175 as well as various types of memory 176 such as ROM 177, Flash 178, and VRAM 179), a power management interface 161, a clock generator interface 162, an audio interface 163 (e.g., for speakers 194), a TO interface 164, a system management bus interface 165, and SC. Flash 166, which can include BIOS 168 and boot code 190. The I/O hub controller 150 may include gigabit Ethernet support.

The system 100, upon power on, may be configured to execute boot code 190 for the BIOS 168, as stored within the SCI. Flash 166, and thereafter processes data under the control of one or more operating systems and application software (e.g., stored in system memory 140). An operating system may be stored in any of a variety of locations and accessed, for example, according to instructions of the BIOS 168. As described herein, a device may include fewer or more features than shown in the system 100 of FIG. 6.

As will be appreciated by one skilled in the art, aspects of the present invention may be embodied as a system such as the information handling system 100, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory such as the disc 300 in FIG. 3 (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the drawings and specifications there has been set forth a preferred embodiment of the invention and, although specific terms are used, the description thus given uses terminology in a generic and descriptive sense only and not for purposes of limitation.

What is claimed is:

1. A method of negotiating a fixed price contract between a first party and a second party for the supply of one of goods and services, the method comprising:
the first party generating as a data base stored in an information handling system a taxonomic table of job roles, job skills and compensation values, the information handling system having a processor, memory and program code accessible to the processor;
the first party communicating first party requirements for the supply of one of goods and services to a plurality of second parties and granting the second parties access to the generated data base stored in the information handling system;
each of the second parties generating in response to the communicated first party requirements a bid for a fixed price contract which includes a labor component specifying job roles, job skills and compensation values taken from the taxonomic table to which access has been granted;
the second parties entering and storing the generated bids in the information handling system for review by the first party;
the program code executing on the information handling system compiling bids entered by the plurality of second parties into a spreadsheet showing the cost build up of the elements which make up the bid including details of the labor component specifying job roles, job skills and compensation values taken from the taxonomic table; and
the program code executing on the information handling system ranking bids appearing on the spreadsheet based upon a selected one of total cost build up and labor component.

2. A method according to claim 1 wherein the first party comprises a requester in need of the goods or services for which a bid is solicited and a buyer responsible for the negotiation of a fixed price contract.

3. A method according to claim 1 wherein the first party in granting access to the second party to the generated data base stored in the information handling system grants access to a defined subset of the taxonomic table relevant to the communicated requirements.

4. A method according to claim 1 wherein the second party in generating a bid defines for the first party the labor component needed to meet the first party communicated requirements.

5. An apparatus comprising:
an information handling system having a processor, memory and program code accessible to the processor;
an input channel through which data is entered into said information handling system;
said program code when executing on said processor enabling:
a first party to enter data through said input channel and generate as a data base stored in said memory a taxonomic table of job roles, job skills and compensation values;
the first party to communicate first party requirements for the supply of one of goods and services to a plurality of second parties and grant the second parties access to the generated data base stored in the information handling system;
each of the second parties to generate in response to the communicated first party requirements a bid for a fixed price contract which includes a labor component specifying job roles, job skills and compensation values taken from the taxonomic table to which access has been granted;
the second parties to enter and store the generated bid in the information handling system for review by the first party;
the program code when executing on the information handling system compiling bids entered by the plurality of second parties into a spreadsheet showing the cost build up of the elements which make up the bid including details of the labor component specifying job roles, job skills and compensation values taken from the taxonomic table; and
the program code when executing on the information handling system ranking bids appearing on the spreadsheet based upon a selected one of total cost build up and labor component.

6. An apparatus according to claim 5 wherein said program code when executing on said processor enables access by a requester in need of the goods or services for which a bid is solicited and a buyer responsible for the negotiation of a fixed price contract, the requester and buyer together being members of the first party.

7. An apparatus according to claim 5 wherein said program code when executing on said processor enables the first party, in granting access to the second party to the generated data base stored in the information handling system, to grant access to a defined subset of the taxonomic table relevant to the communicated requirements.

8. An apparatus according to claim 5 wherein said program code when executing on said processor enables the second party, in generating a bid, to define for the first party the labor component needed to meet the first party communicated requirements.

9. An apparatus comprising:
a computer readable storage medium;
program code stored on said medium and accessible to a processor in an information handling system, said program code when executing on the processor enabling:
a first party to enter data and generate as a data base stored in the information handling system a taxonomic table of job roles, job skills and compensation values;
the first party to communicate first party requirements for the supply of one of goods and services to a second party and grant the second party access to the generated data base stored in the information handling system;
the second party to generate in response to the communicated first party requirements a bid for a fixed price contract which includes a labor component specifying job roles, job skills and compensation values taken from the taxonomic table to which access has been granted;
the second party to enter and store the generated bid in the information handling system for review by the first party;
the program code when executing on the information handling system compiling bids entered by the plurality of second parties into a spreadsheet showing the cost build up of the elements which make up the bid including details of the labor component specifying job roles, job skills and compensation values taken from the taxonomic table; and
the program code when executing on the information handling system ranking bids appearing on the spreadsheet based upon a selected one of total cost build up and labor component.

10. An apparatus according to claim 9 wherein said program code when executing on said processor enables access by a requester in need of the goods or services for which a bid is solicited and a buyer responsible for the negotiation of a fixed price contract, the requester and buyer together being members of the first party.

11. An apparatus according to claim 9 wherein said program code when executing on said processor enables the first party, in granting access to the second party to the generated data base stored in the information handling system, to grant access to a defined subset of the taxonomic table relevant to the communicated requirements.

12. An apparatus according to claim 9 wherein said program code when executing on said processor enables the second party, in generating a bid, to define for the first party the labor component needed to meet the first party communicated requirements.
